(19) United States
(12) Patent Application Publication
(10) Pub. No.: US 2011/0070128 A1
(43) Pub. Date: Mar. 24, 2011

(54) Laser Crystallization Apparatus

(76) Inventors: Sang-Jo Lee, Yongin-City (KR); Kyong-Ho Park, Yongin-city (KR)

(21) Appl. No.: 12/923,438

(22) Filed: Sep. 21, 2010

(30) Foreign Application Priority Data
Sep. 22, 2009 (KR) 10-2009-0089801

(51) Int. Cl. B01D 9/00

(52) U.S. Cl. 422/119; 422/245.1

(57) ABSTRACT

A laser crystallization apparatus includes a box main body having an interior region, a barrier wall demarcating the interior region of the box main body into first and second operation chambers, the barrier wall having a through hole connecting the first and second operation chambers, a gas inflow port at one side of the first operation chamber, and a plurality of flow control plates in the second operation chamber and adjacent to the barrier wall.

### BACKGROUND

1. Field

Embodiments relate to a laser crystallization apparatus.

2. Description of the Related Art

A substrate of an organic light emitting diode (OLED) display or a liquid crystal display (LCD), on which pixels are formed, may be made of an insulating material such as glass or plastic. Thus, it may be important to fabricate thin film transistors (TFTs) having characteristics advantageous for a pixel operation without deforming the substrate. For example, the OLED display may use polysilicon TFTs using polysilicon as an active layer, the polysilicon being obtained by depositing amorphous silicon and crystallizing it at a low temperature.

A laser crystallization process such as excimer laser annealing (ELA) may be employed in the crystallization process. The laser crystallization process may include irradiating laser beams having high energy to a portion of an amorphous silicon film that needs to be crystallized. Because the laser crystallization process allows crystallization through instantaneous heating, a portion of the amorphous silicon film may be crystallized without deforming the substrate. When the amorphous silicon film is melted into a liquid state through the irradiation of laser beams and then becomes solid, silicon atoms may be rearranged in a grain form having good crystalline characteristics, such that good electrical characteristics of the polysilicon film may be secured.

The above information disclosed in this Background section is only for enhancement of understanding of the background of the described technology and may contain information that does not form the prior art.

### SUMMARY

Embodiments are therefore directed to a laser crystallization apparatus, which substantially overcomes one or more problems due to limitations and disadvantages of the related art.

It is therefore a feature of an embodiment to provide a laser crystallization apparatus configured to uniformly crystallize amorphous silicon regions of a target.

At least one of the above and other features and advantages may be realized by providing a laser crystallization apparatus, including a box main body having an interior region, a barrier wall demarcating the interior region of the box main body into first and second operation chambers, the barrier wall having a through hole connecting the first and second operation chambers, a gas inflow port at one side of the first operation chamber; and a plurality of flow control plates in the second operation chamber and adjacent to the barrier wall.

The first operation chamber may be configured to receive nitrogen gas via the gas inflow port.

The first operation chamber may be configured to purify the nitrogen gas.

The second operation chamber may receive the nitrogen gas from the first operation chamber via the through hole of the barrier wall.

The plurality of flow control plates may be configured to uniformly spread the nitrogen gas after the nitrogen gas is introduced into the second operation chamber.

The flow control plates may be disposed in a staggered manner.

The flow control plates may be arranged to be perpendicular to the direction in which the nitrogen gas is introduced into the second operation chamber via the through hole of the barrier wall.

The apparatus may further include a laser beam generating unit configured to emit laser beams.

A translucent window may be provided at a region of the second operation chamber, and laser beams emitted from the laser beam generating unit may be made incident to the interior of the second operation chamber through the translucent window.

The flow of nitrogen gas may be adjustable to control an amount of oxygen gas within the second operation chamber, and the laser beam generating unit may be configured to emit laser beams that impinge on a target, the laser beams passing through the nitrogen gas and the oxygen gas distributed within the second operation chamber.

The laser beam generating unit may be configured to emit laser beams that crystallize the target.

The laser beam generating unit may be configured to emit laser beams that convert amorphous silicon regions of the target into crystallized silicon regions.

The apparatus may further include an oxygen concentration measurement unit configured to measure the density of the oxygen gas within the second operation chamber.

### BRIEF DESCRIPTION OF THE DRAWINGS

The above and other features and advantages will become more apparent to those of skill in the art by describing in detail exemplary embodiments with reference to the attached drawings, in which:

FIG. 1 illustrates a laser crystallization apparatus according to an exemplary embodiment; and

FIGS. 2 and 3 illustrate the surfaces of crystallized silicon layers according to an exemplary embodiment and a comparative example, respectively.

### DETAILED DESCRIPTION

Korean Patent Application No. 10-2009-0089801, filed on Sep. 22, 2009, in the Korean Intellectual Property Office, and entitled: “Laser Crystallization Apparatus,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. In the drawing figures, the dimensions of layers and regions may be exaggerated for clarity of illustration. Like reference numerals refer to like elements throughout.

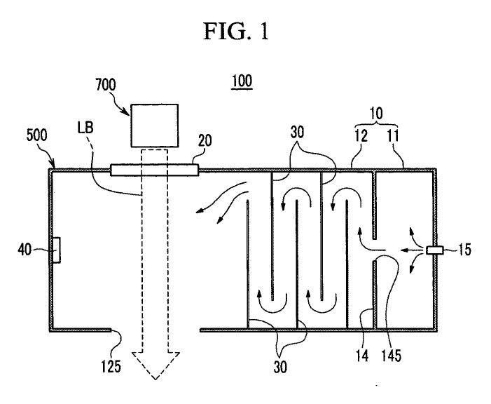

A laser crystallization apparatus 100 according to an exemplary embodiment will now be described with reference to FIG. 1.

During a laser crystallization process, laser beams may be made to be vertically incident to a substrate, i.e., a target, in a space in which nitrogen gas (N₂) and oxygen gas (O₂) are mixed. The oxygen gas (O₂) may be generated as a result of the laser beams being irradiated on an amorphous silicon target during a process of crystallizing the amorphous silicon.

As shown in FIG. 1, the laser crystallization apparatus 100 according to this exemplary embodiment may include a laser beam generating unit 700, and a partially sealed box 500 in which oxygen gas (O₂) and nitrogen gas (N₂) are mixedly present.

The partially sealed box 500 may include a box main body 10, a barrier wall 14, a gas inflow port 15, and a plurality of flow control plates 30. The partially sealed box 500 may further include an oxygen concentration measurement unit 40.

The barrier wall 14 demarcates the interior of the box main body 10 into first and second operation chambers 11 and 12. The barrier wall 14 may have a through hole 145 connecting the first and second operation chambers 11 and 12.

The gas inflow port 15 may be disposed at one side of the first operation chamber 11 of the box main body 10. Nitrogen gas (N₂) may be introduced into the first operation chamber 11 through the gas inflow port 15. Nitrogen gas (N₂) that has been introduced into the first operation chamber 11 may be purified in the first operation chamber 11 and may then move to the second operation chamber 12 through the through hole 145 of the barrier wall 14.

The flow control plates 30 may be disposed adjacent to the barrier wall 14 within the second operation chamber 12. The flow control plates 30 may be staggered or crisscrossed, such that nitrogen gas (N₂) introduced into the second operation chamber 12 via the through hole 145 of the barrier wall 14 may be provided with sufficient stabilization time and distribution space. Thus, nitrogen gas (N₂) may be stably and uniformly distributed while passing through the plurality of flow control plates 30. In FIG. 1, the arrows indicated by a solid line represent a flow path of the nitrogen gas (N₂).

The flow control plates 30 may be arranged to be perpendicular to the direction in which the nitrogen gas is introduced into the second operation chamber 12 through the through hole 145 of the barrier wall 14.

The partially sealed box 500 may include a translucent window 20 formed at one region of the second operation chamber 12. A laser beam LB emitted from the laser beam generating unit 700 may be irradiated onto a substrate (not shown) having an amorphous silicon layer, i.e., a target, after passing through the translucent window 20 and through an internal space of the second operation chamber 12. The substrate having the amorphous silicon layer may be disposed within the second operation chamber 12 or outside the second operation chamber 12.

Where the substrate is disposed outside the second operation chamber 12, the second operation chamber 12 may be provided with an irradiation opening 125 formed at the side opposite to the side of the translucent window 20. The substrate may be disposed right in front of the irradiation opening 125. The laser beam LB may be made to be incident to the interior of the second operation chamber 12 through the translucent window 20, the laser beam LB being output through the irradiation opening 125 to crystallize the amorphous silicon layer on the target substrate. The arrows indicated by the dotted lines in FIG. 1 represent a path along which the laser beam LB is irradiated.

In the process of crystallizing the amorphous silicon layer using the laser beam LB, oxygen gas (O₂) may be generated. If the density of oxygen gas (O₂) within the second operation chamber 12 is overly increased due to oxygen generated during the crystallization process, the surface of the crystallized silicon layer can possibly roughen due to silicon dioxide (SiO₂) formation, the silicon dioxide (SiO₂) being generated as silicon (Si) and oxygen react. Thus, if the density of the oxygen gas (O₂) measured by the oxygen concentration measurement unit 40 is too high, the amount of nitrogen gas (N₂) introduced through the gas inflow port 15 may be adjusted to be increased to control the density of the oxygen gas (O₂).

If the nitrogen gas (N₂) introduced through the gas inflow port 15 is not sufficiently uniformly distributed at the inner side of the second operation chamber 12, such non-uniformity of the nitrogen gas (N₂) may be evidenced as irregularities at the surface of the crystallized silicon layer. For example, irregularities may make the surface of the crystallized silicon layer appear blurred, i.e., to have spots. Thus, according to this exemplary embodiment, the nitrogen gas (N₂) introduced through the gas inflow port 15 may be stably and uniformly distributed within the second operation chamber 12 upon passing through the plurality of flow control plates 30. As such, the laser crystallization apparatus according to this exemplary embodiment may stably crystallize amorphous silicon.

In detail, the laser crystallization apparatus 100 according to this exemplary embodiment may prevent the surface of the crystallized silicon layer from becoming roughening by silicon dioxide (SiO₂) that is generated as silicon (Si) and oxygen gas (O₂) react. Thus, the laser crystallization apparatus 100 may prevent the surface of the crystallized silicon layer from becoming blurred due to non-uniform distribution of the nitrogen gas (N₂).

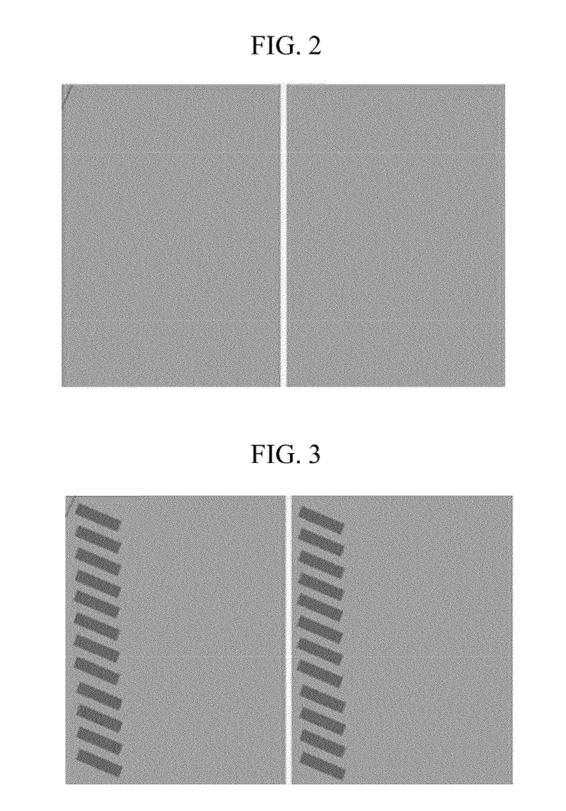

A comparison of an exemplary embodiment with a comparative example will now be described with reference to FIGS. 2 and 3, respectively.

FIG. 2 shows how a surface of the silicon layer would look when crystallized by the laser crystallization apparatus using the plurality of flow control plates, according to an exemplary embodiment. FIG. 3 shows how a surface of a silicon layer would look when crystallized through a laser crystallization apparatus without using a plurality of flow control plates, according to the comparative example.

As shown in FIG. 2, the surface of the silicon layer crystallized through the laser crystallization apparatus according to the exemplary embodiment does not have any blur (or spots). In contrast, the surface of the silicon layer crystallized through a laser crystallization apparatus according to the comparative example has certain patterns of blur as shown in FIG. 3. Thus, the laser crystallization apparatus according to an exemplary embodiment may more stably crystallize the amorphous silicon, based on the comparison between the exemplary embodiment and the comparative example.

As described above, a laser crystallization apparatus according to an embodiment may be configured to control an amount of ambient oxygen gas (O₂), the oxygen gas (O₂) being generated when laser beams are irradiated to crystallize the amorphous silicon. As such, the density of oxygen gas (O₂) may be prevented from becoming overly high, thereby reducing or eliminating a reaction between silicon (Si) and oxygen (O₂) would react to generate silicon dioxide (SiO₂), such silicon dioxide (SiO₂) having a tendency to roughen the surface of the crystallized silicon. Thus, the density of oxygen gas (O₂) produced during crystallization or otherwise present in the apparatus may be adjusted to have a proper level when crystallization occurs by injecting nitrogen gas (N₂). Further, the injected nitrogen gas (N₂) may be controlled to be uniformly distributed, as excessive non-uniformity in the injected nitrogen gas (N₂) may be projected to the crystallized surface and thereby generate a defective crystallized surface by making it blurred or spotty.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A laser crystallization apparatus, comprising:
a box main body having an interior region;
a barrier wall demarcating the interior region of the box main body into first and second operation chambers, the barrier wall having a through hole connecting the first and second operation chambers;
a gas inflow port at one side of the first operation chamber; and
a plurality of flow control plates in the second operation chamber and adjacent to the barrier wall.

2. The apparatus as claimed in claim 1, wherein the first operation chamber is configured to receive nitrogen gas via the gas inflow port.

3. The apparatus as claimed in claim 2, wherein the first operation chamber is configured to purify the nitrogen gas.

4. The apparatus as claimed in claim 2, wherein the second operation chamber receives the nitrogen gas from the first operation chamber via the through hole of the barrier wall.

5. The apparatus as claimed in claim 4, wherein the plurality of flow control plates is configured to uniformly spread the nitrogen gas after the nitrogen gas is introduced into the second operation chamber.

6. The apparatus as claimed in claim 5, wherein the flow control plates are disposed in a staggered manner.

7. The apparatus as claimed in claim 6, wherein the flow control plates are arranged to be perpendicular to the direction in which the nitrogen gas is introduced into the second operation chamber via the through hole of the barrier wall.

8. The apparatus as claimed in 1, further comprising a laser beam generating unit configured to emit laser beams.

9. The apparatus as claimed in 8, wherein a translucent window is provided at a region of the second operation chamber, and laser beams emitted from the laser beam generating unit are made incident to the interior of the second operation chamber through the translucent window.

10. The apparatus as claimed in 9, wherein:
the flow of nitrogen gas is adjustable to control an amount of oxygen gas within the second operation chamber, and
the laser beam generating unit is configured to emit laser beams that impinge on a target, the laser beams passing through the nitrogen gas and the oxygen gas distributed within the second operation chamber.

11. The apparatus as claimed in 10, wherein the laser beam generating unit is configured to emit laser beams that crystallize the target.

12. The apparatus as claimed in 11, wherein the laser beam generating unit is configured to emit laser beams that convert amorphous silicon regions of the target into crystallized silicon regions.

13. The apparatus as claimed in 10, further comprising an oxygen concentration measurement unit configured to measure the density of the oxygen gas within the second operation chamber.
